(19) United States
(12) Patent Application Publication
(10) Pub. No.: US 2023/0204001 A1
(43) Pub. Date: Jun. 29, 2023

(54) CONTROLLER AND CONTROL METHOD FOR INTERNAL COMBUSTION ENGINE

(71) Applicant: TOYOTA JIDOSHA KABUSHIKI KAISHA, Toyota-shi (JP)

(72) Inventors: Masashi MIZUNO, Toyota-shi (JP); Yuya SHIMOZATO, Miyoshi-shi (JP)

(73) Assignee: TOYOTA JIDOSHA KABUSHIKI KAISHA, Toyota-shi (JP)

(21) Appl. No.: 18/055,436

(22) Filed: Nov. 15, 2022

(30) Foreign Application Priority Data
Dec. 24, 2021 (JP) 2021-211241

(51) Int. Cl. F02D 41/10

(52) U.S. Cl. CPC F02D 41/107; F02D 2200/101; F02D 2200/602; F02D 2200/1002; F02D 2250/28

(57) ABSTRACT

The engine controller includes storage which stores a fuel efficiency operation line for optimizing engine fuel consumption and a booming noise avoidance operation line for keeping the booming noise below a certain limit. The operation point region where the booming noise exceeding the certain limit is generated is a booming noise region. The fuel efficiency operation line passes through the booming noise region. In contrast, the booming noise avoidance operation line does not pass through the booming noise region. The controller controls the engine according to the booming noise avoidance operation line. The controller controls the engine according to the fuel efficiency operation line for a predetermined period after determining that the driver intends to change the speed of the vehicle.

### RELATED APPLICATION

The present application claims priority of Japanese Patent Application No. 2021-211241 filed on Dec. 24, 2021, the disclosure of which is hereby incorporated by reference herein in its entirety.

### BACKGROUND

### 1. Field

The present disclosure relates to a controller and control method for an internal combustion engine.

### 2. Description of Related Art

Japanese Laid-Open Patent Application Publication No. 2010-138751 discloses a controller for an internal combustion engine.

When the rotational speed of the internal combustion engine is within a predetermined range, noise referred to as booming noise may be produced in the vehicle interior.

The booming noise will be described. The cycle of combustion in an internal combustion engine having a plurality of cylinders varies in accordance with the rotational speed of the internal combustion engine. When combustion is performed in a certain cycle, the combustion results in cyclic vibration that resonates the power transmission system from the internal combustion engine to the driving wheels. The booming noise is noise caused by the resonance.

The booming noise increases as the output torque of the internal combustion engine increases. Thus, even if the rotational speed of the internal combustion engine is within a predetermined range, the output torque is limited to keep the booming noise below a certain limit.

The controller controls the internal combustion engine according to an operation line. The operation line is data of multiple target operation points for the internal combustion engine. Each of the plurality of target operation points is a set of a target rotational speed and a target output torque for the internal combustion engine. The controller controls the internal combustion engine so that the rotational speed matches the target rotational speed and the average value of the output torque matches the target output torque.

The controller sets the operation line so that the output torque is greatly restricted when the fluctuation of the output torque is large. As a result, when the rotational speed of the internal combustion engine is within a predetermined range, the booming noise can be kept below a certain limit.

The controller sets the operation line based on a fuel efficiency operation line for optimizing the fuel consumption of the internal combustion engine. If the controller controls the internal combustion engine according to the fuel efficiency operation line, booming noise exceeding the certain limit may be generated when the rotational speed of the internal combustion engine is within the predetermined range.

The operation line that the controller sets restricts the output torque more than the fuel efficiency operation line when the rotational speed of the internal combustion engine is within the predetermined range. Thus, the above controller has room for improvement in terms of improving fuel efficiency.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

One aspect of the present disclosure is a controller for an internal combustion engine including processing circuitry and storage, where (i) the storage stores information of a plurality of operation lines, (ii) each of the operation lines is data including a plurality of target operation points for the internal combustion engine, (iii) each of the target operation points is a set of a target rotational speed and a target output torque for the internal combustion engine, (iv) the operation lines include a fuel efficiency operation line for optimizing fuel consumption of the internal combustion engine and a booming noise avoidance operation line for keeping a booming noise below a certain limit in the internal combustion engine, (v) an operation point region in which the booming noise exceeding the certain limit is generated is a booming noise region, (vi) the booming noise region is a region in which a rotational speed of the internal combustion engine is within a predetermined range and an output torque of the internal combustion engine is greater than or equal to an output torque threshold determined in accordance with the rotational speed of the internal combustion engine, (vii) the fuel efficiency operation line passes through the booming noise region, whereas the booming noise avoidance operation line sets the target output torque to be lower than that of the fuel efficiency operation line so as not to pass through the booming noise region. The processing circuitry is configured to execute a first process that controls the internal combustion engine according to the booming noise avoidance operation line, a determination process that determines whether a driver intends to change a speed of a vehicle based on an accelerator position change rate that is a change amount of an accelerator position per unit time, and a second process that controls the internal combustion engine according to the fuel efficiency operation line for a predetermined period after determination that the driver intends to change the speed of the vehicle.

One aspect of the present disclosure is a method for controlling an internal combustion engine, where (i) storage stores information of a plurality of operation lines, (ii) each of the operation lines is data including a plurality of target operation points for the internal combustion engine, (iii) each of the target operation points is a set of a target rotational speed and a target output torque for the internal combustion engine, (iv) the operation lines include a fuel efficiency operation line for optimizing fuel consumption of the internal combustion engine and a booming noise avoidance operation line for keeping a booming noise below a certain limit in the internal combustion engine, (v) an operation point region in which the booming noise exceeding the certain limit is generated is a booming noise region, (vi) the booming noise region is a region in which a rotational speed of the internal combustion engine is within a predetermined range and an output torque of the internal combustion engine is greater than or equal to an output torque threshold determined in accordance with the rotational speed of the internal combustion engine, (vii) the fuel efficiency operation line passes through the booming noise region, whereas the booming noise avoidance operation line sets the target output torque to be lower than that of the fuel efficiency operation line so as not to pass through the booming noise region. The method includes executing a process that obtains the booming noise avoidance operation line and the fuel efficiency operation line from the storage, executing a first process that controls the internal combustion engine according to the booming noise avoidance operation line, executing a determination process that determines whether a driver intends to change a speed of a vehicle based on an accelerator position change rate that is a change amount of an accelerator position per unit time, and executing a second process that controls the internal combustion engine according to the fuel efficiency operation line for a predetermined period after determination that the driver intends to change the speed of the vehicle.

Other features and aspects will be apparent from the following detailed description, the drawings, and the claims.

### BRIEF DESCRIPTION OF THE DRAWINGS

FIG. 1 is a schematic diagram of a hybrid electric vehicle to which a controller for an internal combustion engine according to one embodiment is applied.

FIG. 2 is a diagram showing the fuel efficiency operation line and the booming noise avoidance operation line used for controlling the internal combustion engine.

FIG. 3 is a flowchart relating to control of the internal combustion engine according to the operation line.

FIG. 4 is a diagram showing control of the internal combustion engine during acceleration of the hybrid electric vehicle.

FIG. 5 is a diagram showing control of the internal combustion engine during deceleration of the hybrid electric vehicle.

FIG. 6 is a diagram showing control of the internal combustion engine during moderate acceleration of the hybrid electric vehicle.

FIG. 7 is a diagram showing control of the internal combustion engine during moderate deceleration of the hybrid electric vehicle.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

A controller for an internal combustion engine according to one embodiment will be described below with reference to the drawings.

### Configuration of Hybrid Electric Vehicle 10

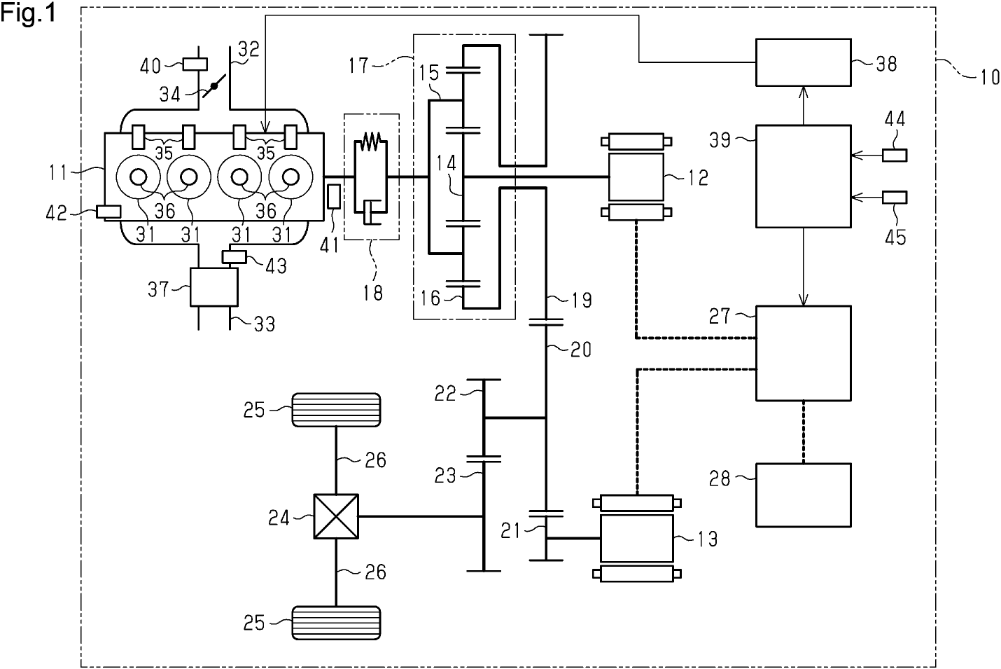

A hybrid electric vehicle 10 to which a controller for an internal combustion engine according to one embodiment is applied will be described with reference to FIG. 1.

As shown in FIG. 1, a hybrid electric vehicle 10 (hereinafter simply referred to as a vehicle 10) includes an internal combustion engine 11 (hereinafter simply referred to as an engine 11). In addition, the vehicle 10 includes two motor generators (first motor generator 12 and second motor generator 13), each functioning as both a motor that serves as a driving source of the vehicle 10 and a generator that receives power from the engine 11 and generates power.

A planetary gear mechanism 17 is provided on the vehicle 10. The planetary gear mechanism 17 has three rotating elements. That is, the planetary gear mechanism 17 has a sun gear 14, a planetary carrier 15, and a ring gear 16. The engine 11 is connected to the planetary carrier 15 of the planetary gear mechanism 17 via a transaxle damper 18. The first motor generator 12 is connected to the sun gear 14 of the planetary gear mechanism 17. A counter drive gear 19 is integrally provided with the ring gear 16 of the planetary gear mechanism 17. A counter driven gear 20 is meshed with the counter drive gear 19. The second motor generator 13 is connected to a reduction gear 21, which is meshed with the counter driven gear 20.

The final drive gear 22 is integrally rotatably connected to the counter driven gear 20. The final driven gear 23 is meshed with the final drive gear 22. The drive shaft 26 of the wheel 25 is connected to the final driven gear 23 via the differential mechanism 24.

The first motor generator 12 and the second motor generator 13 are electrically connected to a battery 28 via a power control unit (PCU) 27. The PCU 27 regulates the amount of power supplied from the battery 28 to the first motor generator 12 and the second motor generator 13. The PCU 27 regulates the amount of charge supplied to the battery 28 from the first motor generator 12 and the second motor generator 13.

The engine 11 has a plurality of cylinders 31, an intake passage 32, and an exhaust passage 33. Intake air flows through intake passage 32 into each cylinder 31. Air-fuel mixture is burned in each cylinder 31. Exhaust generated by combustion in each cylinder 31 flows through exhaust passage 33. The intake passage 32 is provided with a throttle valve 34, which is a valve for adjusting the flow rate of the intake air flowing through the intake passage 32. In the engine 11, each cylinder 31 is provided with fuel injection valve 35 for injecting fuel into the intake air and a spark plug 36 for igniting the mixture of fuel and intake air with a spark discharge. In addition, the exhaust passage 33 of the engine 11 is provided with a filter 37 that collects particulate matter (PM) from the exhaust. An oxidation catalyst that accelerates oxidation reaction of the collected PM is supported in the surface of a porous material forming the filter 37.

The vehicle 10 is equipped with an engine controller 38, which is an electronic controller that controls the engine 11. In addition, the vehicle 10 is equipped with a vehicle controller 39, which comprehensively controls the engine controller 38 and PCU 27. That is, a controller for an internal combustion engine corresponds to the engine controller 38 and the vehicle controller 39. Each of the engine controller 38 and the vehicle controller 39 is a computer unit. The computer unit includes storage, a Central Processing Unit (CPU), and a Random Access Memory (RAM). The storage stores control programs and data. The CPU executes the programs stored in the storage. The RAM is the work area when the CPU executes a program. For example, the storage may be Read Only Memory (ROM).

The detection signal of an air flow meter 40 that detects the intake air amount GA of the engine 11 is input to the engine controller 38. The detection signal of a crank angle sensor 41 that detects the rotation angle of the engine 11 is input to the engine controller 38. The detection signal of the water temperature sensor 42 that detects the temperature of the coolant of the engine 11 (engine coolant temperature TW) is input to the engine controller 38. The detection signal of an exhaust temperature sensor 43 that detects the exhaust temperature TE (temperature of the exhaust flowing into filter 37) is input to the engine controller 38. The engine controller 38 calculates the rotational speed of the engine 11 (engine rotational speed NE) based on the detection result of the crank angle sensor 41. In addition, the engine controller 38 calculates the engine load factor KL based on the engine rotational speed NE and the intake air amount GA. The engine load factor KL will be described. The amount of air flowing into each cylinder 31 in the intake stroke is referred to as the cylinder inflow air amount. The engine load factor KL represents the ratio of the current cylinder inflow air amount to the cylinder inflow amount when the engine 11 is stably operated with the throttle valve 34 in a fully open state at the current engine rotational speed NE.

The current IB, voltage VB, and temperature TB of the battery 28 are input to the vehicle controller 39. Then, the vehicle controller 39 calculates the state of charge (SOC) of the battery 28 based on the current IB, the voltage VB, and the temperature TB. Further, the detection signal of an accelerator pedal sensor 44 for detecting the accelerator position ACCP, which is the amount the accelerator pedal is depressed by the driver, is input to the vehicle controller 39. The detection signal of the vehicle speed sensor 45 that detects the vehicle speed V, which is the speed of the vehicle 10, is input to the vehicle controller 39. Then, the vehicle controller 39 calculates the vehicle required power, which is the required value of the power of the vehicle 10, based on the accelerator position ACCP and the vehicle speed V. The vehicle controller 39 calculates the required engine output, which is the required value of the engine output, based on the vehicle required power, SOC, and the like. The vehicle controller 39 calculates the MG1 required torque, which is the required value of the power running / regenerative torque of the first motor generator 12, based on the vehicle required power, SOC, and the like. The vehicle controller 39 calculates the MG2 required torque, which is the required value of the power running / regenerative torque of the second motor generator 13, based on the vehicle required power, SOC, and the like. Then, driving control of vehicle 10 is executed. Specifically, the engine control unit 38 controls the output of the engine 11 according to the required engine output, and the PCU 27 controls the torque of the first motor generator 12 and the second motor generator 13 according to the MG1 required torque and the MG2 required torque.

The vehicle controller 39 switches between hybrid driving, in which the engine 11 is running, and motor driving, in which the engine 11 is stopped, during driving control of the vehicle 10. The vehicle controller 39 automatically switches between the hybrid driving and the motor driving based on the accelerator position ACCP, the vehicle speed V, SOC, and the like. The vehicle controller 39 computes the value of the required engine output to be “0” during the motor driving and to be a positive value during the hybrid driving. The engine controller 38 stops the operation of the engine 11 when the value of the required engine output switches from a positive value to “0”. The engine controller 38 starts the engine 11 when the value of the requested engine output switches from “0” to a positive value. This allows for switching between hybrid driving and motor driving.

### Overview of Control of Engine 11 According to Operation Line

The storage stores information of a plurality of operation lines. Each of the plurality of operation lines is data including a plurality of target operation points for the engine 11. Each of the plurality of target operation points is a set of a target rotational speed TRS and a target output torque TOT for the engine 11.

As described above, the vehicle controller 39 calculates the requested engine output, which is the requested value of the engine output, based on the vehicle requested power, SOC, and the like. Then, the engine controller 38 controls the output of the engine 11 according to the required engine output. Here, the engine output is the product of the engine rotational speed NE and the output torque OT of the engine 11. Thus, the engine controller 38 controls the engine rotational speed NE to become the target rotational speed TRS and the output torque OT to become the target output torque TOT so as to achieve the required engine output. In other words, the engine controller 38 controls the engine 11 according to one of the plurality of the operation lines. The engine controller 38 basically executes a first process of controlling the engine 11 according to a booming noise avoidance operation line NVLn, which will be described later. As will be described later with reference to FIG. 3, the engine controller 38 controls the engine 11 according to the fuel efficiency operation line FELn for a predetermined period when a predetermined condition is satisfied. After the predetermined period elapses, the engine controller 38 again controls the engine 11 according to the booming noise avoidance operation line NVLn.

### Fuel Efficiency Operation Line FELn and Booming Noise Avoidance Operation Line NVLn

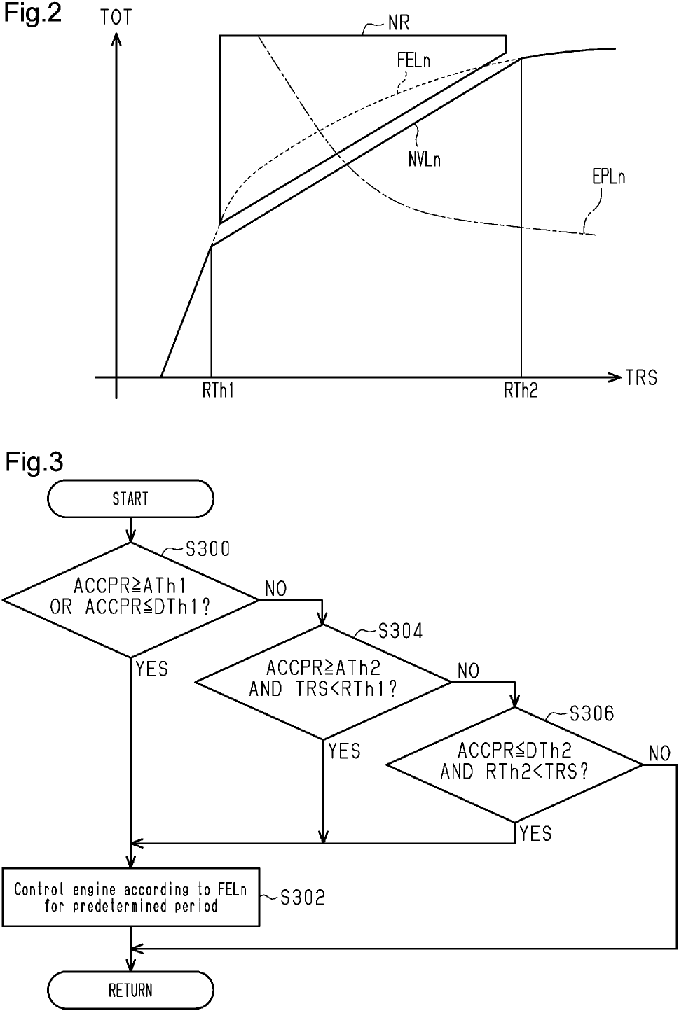

The fuel efficiency operation line FELn and the booming noise avoidance operation line NVLn will be described with reference to FIG. 2.

The plurality of operation lines includes the fuel efficiency operation line FELn for optimizing a fuel consumption of the engine 11 and the booming noise avoidance operation line NVLn for keeping a booming noise below a certain limit in the engine 11. The operation point region where the booming noise exceeding the certain limit is generated is a booming noise region NR. In the booming noise region NR, the rotational speed NE is within a predetermined range and an output torque OT of the engine 11 is greater than or equal to an output torque threshold determined according to the rotational speed NE. The fuel efficiency operation line FELn is an operation line that passes through the booming noise region NR. In contrast, the booming noise avoidance operation line NVLn is an operation line that sets the target output torque TOT to be lower than that of the fuel efficiency operation line FELn so as not to pass through the booming noise region NR.

As indicated by the solid line in FIG. 2, when the target rotational speed TRS is equal to or less than the first rotational speed threshold RTh1, the target output torque TOT of the fuel efficiency operation line FELn matches the target output torque TOT of the booming noise avoidance operation line NVLn.

As indicated by the solid line in FIG. 2, when the target rotational speed TRS is equal to or greater than the second rotational speed threshold RTh2, which is greater than the first rotational speed threshold RTh1 , the target output torque TOT of the fuel efficiency operation line FELn matches the target output torque TOT of the booming noise avoidance operation line NVLn.

As shown in FIG. 2, the booming noise region NR is located in a range where the engine rotational speed NE is between the first rotational speed threshold RTh1 and the second rotational speed threshold RTh2.

When the target rotational speed TRS is greater than the first rotational speed threshold RTh1 and less than the second rotational speed threshold RTh2, the target output torque TOT of the fuel efficiency operation line FELn indicated by the dashed line is greater than the target output torque TOT of the booming noise avoidance operation line NVLn indicated by the solid line. In other words, the fuel efficiency operation line FELn diverges from the booming noise avoidance operation line NVLn at the first rotational speed threshold RTh1 such that the target output torque TOT of the fuel efficiency operation line FELn is greater than the target output torque TOT of the booming noise avoidance operation line NVLn. The fuel efficiency operation line FELn diverges from the booming noise avoidance operation line NVLn at the second rotational speed threshold RTh2 such that the target output torque TOT of the fuel efficiency operation line FELn is greater than the target output torque TOT of the booming noise avoidance operation line NVLn.

In FIG. 2, the equal power line EPLn is indicated by an alternate long and short dash line. The equal power line EPLn is a collection of target operation points that achieve a given required engine output. Focusing on the intersection of the equal power line EPLn and the booming noise avoidance operation line NVLn and the intersection of the equal power line EPLn and the fuel efficiency operation line FELn, the target rotational speed TRS of the booming noise avoidance operation line NVLn is greater than the target rotational speed TRS of the fuel efficiency operation line FELn when achieving a given required engine output. That is, when the engine 11 is controlled according to the booming noise avoidance operation line NVLn, the engine rotational speed NE becomes higher than that when the engine 11 is controlled according to the fuel efficiency operation line FELn. Such a high engine rotational speed NE increases fuel consumption. Thus, when the engine 11 is controlled according to the booming noise avoidance operation line NVLn, more fuel is consumed than when the engine 11 is controlled according to the fuel efficiency operation line FELn.

### Control of Engine 11 According to Operation Line

The control of the engine 11 according to the operation line will be described with reference to FIG. 3. The engine controller 38 repeatedly executes the process shown in FIG. 3. As described above, the engine controller 38 basically executes the first process of controlling the engine 11 according to the booming noise avoidance operation line NVLn. The engine controller 38 executes a second process that controls the engine 11 according to the fuel efficiency operation line FELn for a predetermined period when a predetermined condition is satisfied. Satisfying the predetermined condition means that an affirmative determination is made in step S300, step S304, or step S306.

At step S300, the engine controller 38 determines whether an accelerator position change rate ACCPR is a first acceleration threshold ATh1 or greater or a first deceleration threshold DTh1 or less. Here, the accelerator position change rate ACCPR is a change amount in the accelerator position ACCP per unit time. The first acceleration threshold AThl is set to allow for recognition of whether the driver is intending to accelerate the vehicle. The first acceleration threshold ATh1 is a positive value. The first deceleration threshold DTh1 is set to allow for recognition of whether the driver intends to decelerate the vehicle. The first deceleration threshold DTh1 is a negative value. That is, the engine controller 38 determines that the driver intends to accelerate the vehicle 10 when the accelerator position change rate ACCPR is greater than or equal to the first acceleration threshold Ath1. Further, the engine controller 38 determines that the driver intends to decelerate the vehicle 10 when the accelerator position change rate ACCPR is less than or equal to the first deceleration threshold Dth1.

When the engine controller 38 makes an affirmative determination in step S300 (step S300: YES), the engine controller 38 proceeds to step S302. In step S302, the engine controller 38 controls the engine 11 according to the fuel efficiency operation line FELn for a predetermined period.

When the engine controller 38 makes a negative determination in step S300 (step S300: NO), the engine controller 38 proceeds to step S304.

At step S304, the engine controller 38 determines whether the target rotational speed TRS is less than the first rotational speed threshold RTh1 and whether the accelerator position change rate ACCPR is greater than or equal to a second acceleration threshold ATh2. When the engine controller 38 makes an affirmative determination at step S304 (S304: YES), the engine controller 38 proceeds to step S302. That is, the engine controller 38 also determines that the driver intends to accelerate the vehicle 10 when the target rotational speed TRS is less than the first rotational speed threshold RTh1 and the accelerator position change rate ACCPR is greater than or equal to the second acceleration threshold ATh2. The second acceleration threshold ATh2 is a positive value and less than the first acceleration threshold ATh1. Thus, making an affirmative determination at step S304 means determining that the driver is intending to moderately accelerate the vehicle 10.

When the engine controller 38 makes a negative determination at step S304 (S304: NO), the engine controller 38 proceeds to step S306.

At step S306, the engine controller 38 determines whether the target rotational speed TRS is greater than the second rotational speed threshold RTh2 and whether the accelerator position change rate ACCPR is less than or equal to a second deceleration threshold DTh2. When the engine controller 38 makes an affirmative determination at step S306 (S306: YES), the engine controller 38 proceeds to step S302. That is, the engine controller 38 also determines that the driver intends to decelerate the vehicle 10 when the target rotational speed TRS is greater than the second rotational speed threshold RTh2 and the accelerator position change rate ACCPR is less than or equal to the second deceleration threshold DTh2. The second deceleration threshold DTh2 is a negative value and greater than the first deceleration threshold DTh1. Thus, making an affirmative determination at step S306 means determining that the driver is intending to moderately decelerate the vehicle 10.

When completing step S302 or when making a negative determination at step S306 (S306: NO), the engine controller 38 ends the current process in FIG. 3.

In this manner, the engine controller 38 executes the determination process through step S300, step S304, or step S306. The determination process is a process of determining whether or not the driver intends to change the vehicle speed V based on the accelerator position change rate ACCPR. When the engine controller 38 determines that the driver intends to change the vehicle speed V, the engine controller 38 proceeds to step S302. At step S302, the engine controller 38 executes the second process. The second process is a process of controlling the engine 11 according to the fuel efficiency operation line FELn for a predetermined period after determining that the driver intends to change the vehicle speed V.

### Control of Engine 11 During Acceleration of Vehicle 10

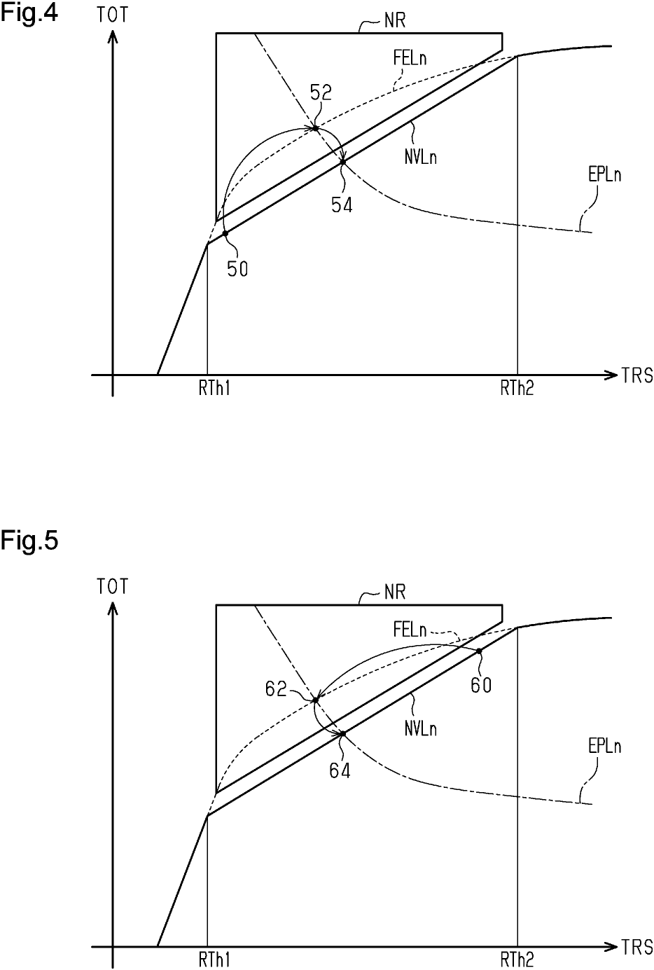

Referring to FIG. 4, the control of the engine 11 during acceleration of the vehicle 10 will be described.

Here, a case will be illustrated where the driver depresses the gas pedal to accelerate the vehicle 10 from a state where the target rotational speed TRS is greater than the first rotational speed threshold RTh1 and less than the second rotational speed threshold RTh2. As indicated by point 50 in FIG. 4, before the gas pedal is depressed, the engine controller 38 controls the engine 11 according to the booming noise avoidance operation line NVLn.

Next, the driver increases the accelerator position ACCP. This increases the required engine output. In FIG. 4, the equal power line EPLn corresponding to the increased required engine output is indicated by an alternate long and short dash line. The engine controller 38 selects the fuel efficiency operation line FELn when the accelerator position change rate ACCPR is greater than or equal to the first acceleration threshold ATh1. As shown in FIG. 4, the engine controller 38 controls the engine 11 by setting the target to point 52, which is the intersection of the equal power line EPLn and the fuel efficiency operation line FELn. That is, the engine controller 38 controls the engine 11 according to the fuel efficiency operation line FELn for a predetermined period. During the predetermined period, the target operation point is in the booming noise region NR. Since the driver intentionally performs the acceleration operation, booming noise will not annoy the driver.

After the predetermined period elapses, as shown in FIG. 4, the engine controller 38 controls the engine 11 by setting the target to point 54, which is the intersection of the equal power line EPLn and the booming noise avoidance operation line NVLn. That is, after the predetermined period elapses, the engine controller 38 again controls the engine 11 according to the booming noise avoidance operation line NVLn.

### Control of Engine 11 During Deceleration of Vehicle 10

Referring to FIG. 5, the control of the engine 11 during deceleration of the vehicle 10 will be described.

Here, a case will be illustrated where the driver reduces the depression of the gas pedal to decelerate the vehicle 10 from a state where the target rotational speed TRS is greater than the first rotational speed threshold RTh1 and less than the second rotational speed threshold RTh2. As indicated by point 60 in FIG. 5, before the vehicle 10 is decelerated, the engine controller 38 controls the engine 11 according to the booming noise avoidance operation line NVLn.

Next, the driver decreases the accelerator position ACCP. This decreases the required engine output. In FIG. 5, the equal power line EPLn corresponding to the decreased required engine output is indicated by an alternate long and short dash line. The engine controller 38 selects the fuel efficiency operation line FELn when the accelerator position change rate ACCPR is less than or equal to the first deceleration threshold DTh1. As shown in FIG. 5, the engine controller 38 controls the engine 11 by setting the target to point 62, which is the intersection of the equal power line EPLn and the fuel efficiency operation line FELn. That is, the engine controller 38 controls the engine 11 according to the fuel efficiency operation line FELn for a predetermined period. During the predetermined period, the target operation point is in the booming noise region NR. Since the driver intentionally performs the deceleration operation, booming noise will not annoy the driver.

After the predetermined period elapses, as shown in FIG. 5, the engine controller 38 controls the engine 11 by setting the target to point 64, which is the intersection of the equal power line EPLn and the booming noise avoidance operation line NVLn. That is, after the predetermined period elapses, the engine controller 38 again controls the engine 11 according to the booming noise avoidance operation line NVLn.

### Control of Engine 11 During Moderate Acceleration of Vehicle 10

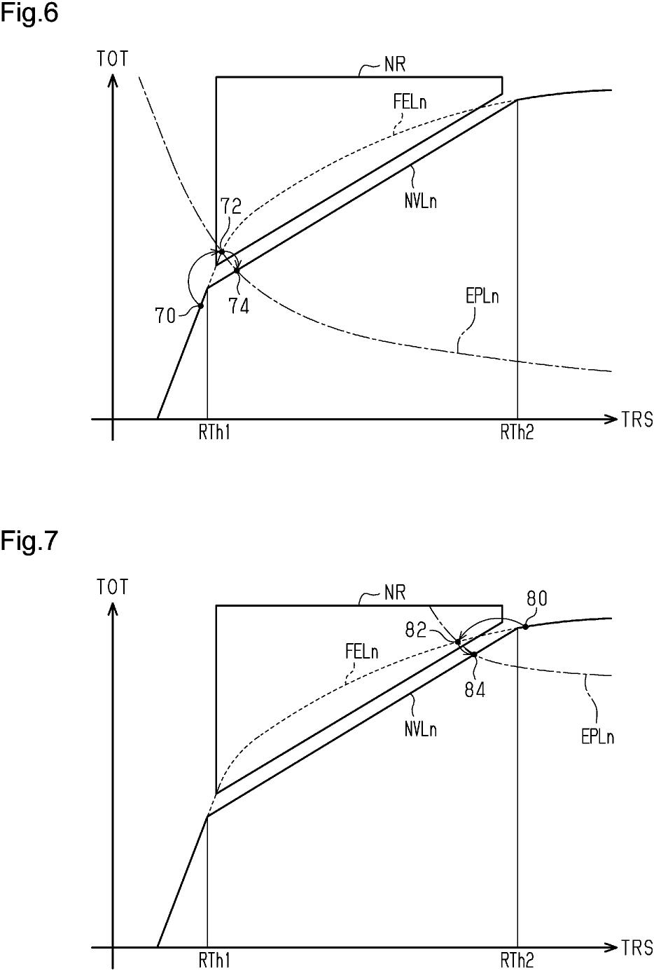

Referring to FIG. 6, the control of the engine 11 during moderate acceleration of the vehicle 10 will be described.

As shown in FIG. 6, when the target rotational speed TRS is less than or equal to the first rotational speed threshold RTh1, the fuel efficiency operation line FELn matches the booming noise avoidance operation line NVLn.

Here, a case will be illustrated where the driver depresses the gas pedal to accelerate the vehicle 10 from the state where the target rotational speed TRS is less than the first rotational speed threshold RTh1. As indicated by point 70 in FIG. 6, before the gas pedal is depressed, the engine controller 38 controls the engine 11 according to the booming noise avoidance operation line NVLn.

Next, the driver increases the accelerator position ACCP. This increases the required engine output. In FIG. 6, the equal power line EPLn corresponding to the increased required engine output is indicated by an alternate long and short dash line.

When the target rotational speed TRS is less than the first rotational speed threshold RTh1, the engine controller 38 selects the fuel efficiency operation line FELn even if the accelerator position change rate ACCPR is greater than or equal to the second acceleration threshold ATh2. Thus, as shown in FIG. 6, the engine controller 38 controls the engine 11 by setting the target to point 72, which is the intersection of the equal power line EPLn and the fuel efficiency operation line FELn. That is, the engine controller 38 controls the engine 11 according to the fuel efficiency operation line FELn for a predetermined period. During the predetermined period, the target operation point is in the booming noise region NR. Since the driver intentionally performs the acceleration operation, booming noise will not annoy the driver.

After the predetermined period elapses, as shown in FIG. 6, the engine controller 38 controls the engine 11 by setting the target to point 74, which is the intersection of the equal power line EPLn and the booming noise avoidance operation line NVLn. That is, after the predetermined period elapses, the engine controller 38 again controls the engine 11 according to the booming noise avoidance operation line NVLn.

In this manner, the engine controller 38 also determines that the driver intends to accelerate the vehicle 10 when the target rotational speed TRS is less than the first rotational speed threshold RTh1 and the accelerator position change rate ACCPR is greater than or equal to the second acceleration threshold ATh2. The second acceleration threshold ATh2 allows the intention of the driver to accelerate the vehicle to be recognized when such intention cannot be recognized with the first acceleration threshold ATh1. For example, when starting the vehicle 10 from a state where the vehicle 10 is at a standstill, the intention of the driver to accelerate the vehicle can be recognized. Alternatively, while the vehicle 10 is cruising at a constant speed, if the vehicle is accelerated to adjusting the vehicle speed V, the intention of the driver to accelerate the vehicle can be recognized.

### Control of Engine 11 During Moderate Deceleration of Vehicle 10

Referring to FIG. 7, the control of the engine 11 during moderate deceleration of the vehicle 10 will be described.

As shown in FIG. 7, when the target rotational speed TRS is greater than or equal to the second rotational speed threshold RTh2, the fuel efficiency operation line FELn matches the booming noise avoidance operation line NVLn.

Here, a case will be illustrated where the driver reduces the depression of the gas pedal to decelerate the vehicle 10 from a state where the target rotational speed TRS is greater than the second rotational speed threshold RTh2. As indicated by point 80 in FIG. 7, before the vehicle 10 is decelerated, the engine controller 38 controls the engine 11 according to the booming noise avoidance operation line NVLn.

Next, the driver decreases the accelerator position ACCP. This decreases the required engine output. In FIG. 7, the equal power line EPLn corresponding to the decreased required engine output is indicated by an alternate long and short dash line.

When the target rotational speed TRS is greater than the second rotational speed threshold RTh2, the engine controller 38 selects the fuel efficiency operation line FELn even if the accelerator position change rate ACCPR is less than or equal to the second deceleration threshold DTh2. Thus, as shown in FIG. 7, the engine controller 38 controls the engine 11 by setting the target to point 82, which is the intersection of the equal power line EPLn and the fuel efficiency operation line FELn. That is, the engine controller 38 controls the engine 11 according to the fuel efficiency operation line FELn for a predetermined period. During the predetermined period, the target operation point is in the booming noise region NR. Since the driver intentionally performs the deceleration operation, booming noise will not annoy the driver.

After the predetermined period elapses, as shown in FIG. 7, the engine controller 38 controls the engine 11 by setting the target to point 84, which is the intersection of the equal power line EPLn and the booming noise avoidance operation line NVLn. That is, after the predetermined period elapses, the engine controller 38 again controls the engine 11 according to the booming noise avoidance operation line NVLn.

In this manner, the engine controller 38 also determines that the driver intends to decelerate the vehicle 10 when the target rotational speed TRS is greater than the second rotational speed threshold RTh2 and the accelerator position change rate ACCPR is less than or equal to the second deceleration threshold DTh2. The second deceleration threshold DTh2 allows the intention of the driver to decelerate the vehicle to be recognized when such intention cannot be recognized with the first deceleration threshold DTh1.

### Advantages of Present Embodiment

(1) The behavior of the power transmission system changes when the vehicle 10 accelerates or decelerates. Thus, noise is generated as the behavior of the power transmission system changes when the vehicle 10 accelerates or decelerates. Thus, when the driver intends to change the vehicle speed V, that is, when the driver intentionally performs an acceleration or deceleration operation, the generation of booming noise will not annoy the driver. In the above configuration, the engine controller 38 controls the engine 11 according to the fuel efficiency operation line FELn for a predetermined period when determined that the driver intends to change the vehicle speed V. That is, during the predetermined period, the engine 11 is controlled according to the fuel efficiency operation line FELn even if the target operation point is in the booming noise region NR. After the predetermined period elapses, the engine controller 38 again controls the engine 11 according to the booming noise avoidance operation line NVLn. Thus, the fuel efficiency can be improved compared to the configuration in which the engine 11 is always controlled according to the booming noise avoidance operation line NVLn.

Accordingly, the above configuration results in the driver being less annoyed by booming noise while improving the fuel efficiency.

(2) In the above configuration, the engine controller 38 controls the engine 11 according to the fuel efficiency operation line FELn for a predetermined period after determining that the driver intends to accelerate the vehicle 10. After the predetermined period elapses, the engine controller 38 again controls the engine 11 according to the booming noise avoidance operation line NVLn. This improves fuel efficiency compared to the configuration in which the engine 11 is always controlled according to the booming noise avoidance operation line NVLn.

(3) In the above configuration, the engine controller 38 controls the engine 11 according to the fuel efficiency operation line FELn for a predetermined period after determining that the driver intends to decelerate the vehicle 10. After the predetermined period elapses, the engine controller 38 again controls the engine 11 according to the booming noise avoidance operation line NVLn. Thus, the fuel efficiency can be improved compared to the configuration in which the engine 11 is always controlled according to the booming noise avoidance operation line NVLn.

(4) In a comparative example, irrespective of the target rotational speed TRS, the engine controller 38 determines that the driver intends to accelerate the vehicle 10 only when the accelerator position change rate ACCPR is greater than or equal to the first acceleration threshold Ath1. In the comparative example, when the accelerator position change rate ACCPR is greater than or equal to the second acceleration threshold ATh2 and less than the first acceleration threshold ATh1, the engine controller 38 will not determine that the driver intends to accelerate the vehicle 10.

The above configuration differs from the comparative example in that the engine controller 38 also determines that the driver intends to accelerate the vehicle 10 when the target rotational speed TRS is less than the first rotational speed threshold RTh1 and the accelerator position change rate ACCPR is greater than or equal to the second acceleration threshold ATh2. In this case, the engine controller 38 controls the engine 11 according to the fuel efficiency operation line FELn for a predetermined period after determining that the driver intends to accelerate the vehicle 10. Thus, the engine 11 is controlled according to the fuel efficiency operation line FELn more frequently than the comparative example. This improves fuel efficiency.

The reason for setting the first acceleration threshold ATh1 and the second acceleration threshold ATh2 will be described below.

When the target rotational speed TRS is greater than the first rotational speed threshold RTh1, the target output torque TOT of the fuel efficiency operation line FELn is greater than the target output torque TOT of the booming noise avoidance operation line NVLn. In such a case, if the target operation point switches between the booming noise avoidance operation line NVLn and the fuel efficiency operation line FELn too frequently, the operation of the engine 11 may become unstable. Thus, the first acceleration threshold ATh1 is set in view of the operation stability of the engine 11.

In a low rotational speed range in which the engine rotational speed NE is less than the first rotational speed threshold RTh1, the vehicle 10 is often moderately accelerated by the driver moderately depressing the gas pedal. In the comparative example, the first acceleration threshold ATh1 is too large to allow for determination that the driver intends to moderately accelerate the vehicle 10. In contrast, in the above configuration, when the target rotational speed TRS is less than the first rotational speed threshold RTh1 in the determination process, it is also determined that the driver intends to accelerate the vehicle 10when the accelerator position change rate ACCPR is greater than or equal to the second acceleration threshold ATh2. The second acceleration threshold ATh2 allows the intention of the driver to accelerate the vehicle to be recognized even if such intention cannot be recognized with the first acceleration threshold ATh1. If the above configuration is adopted, fuel efficiency can be improved for a predetermined period when the vehicle is moderately accelerated such that the engine rotational speed NE increases from a rotational speed range in which the engine rotational speed NE is less than or equal to the first rotational speed threshold RTh1 and becomes greater than the first rotational speed threshold RTh1 .

(5) A comparative example may be contemplated where, irrespective of the target rotational speed TRS, the engine controller 38 determines that the driver intends to decelerate the vehicle 10 only when the accelerator position change rate ACCPR is equal to or less than the first deceleration threshold Dth1. In the comparative example, when the accelerator position change rate ACCPR is equal to or less than the second deceleration threshold DTh2 and greater than the first deceleration threshold DTh1, the engine controller 38 never determines that the driver intends to decelerate the vehicle 10.

The above configuration differs from the comparative example in that , the engine controller 38 determines that the driver intends to decelerate the vehicle 10 even when the target rotational speed TRS is greater than the second rotational speed threshold RTh2 and the accelerator position change rate ACCPR is less than or equal to the second deceleration threshold DTh2. In this case, the engine controller 38 controls the engine 11 according to the fuel efficiency operation line FELn for a predetermined period after determining that the driver intends to decelerate the vehicle 10. Thus, the engine 11 is controlled more frequently according to the fuel efficiency operation line FELn than the comparative example. This improves fuel efficiency.

The reason for setting the first deceleration threshold DTh1 and the second deceleration threshold DTh2 will be described below.

When the target rotational speed TRS is less than the second rotational speed threshold RTh2, the target output torque TOT of the fuel efficiency operation line FELn is greater than the target output torque TOT of the booming noise avoidance operation line NVLn. In such a case, if the target operation point switches between the booming noise avoidance operation line NVLn and the fuel efficiency operation line FELn too frequently, the operation of the engine 11 may become unstable. Thus, the first deceleration threshold DTh1 is set in view of the operation stability of the engine 11.

When the vehicle 11 is traveling at a high speed, the engine 11 runs in a high rotational speed range in which the engine speed NE is greater than the second rotational speed threshold RTh2. When the vehicle is traveling at a high speed and the engine 11 is running in the high rotational speed range, the vehicle 10 may be moderately decelerated to adjust the speed by the driver moderately releasing the gas pedal to moderately decelerate and adjust the speed of the vehicle 10. In the comparative example, the first deceleration threshold DTh1 is too small to allow for determination that the driver intends to moderately decelerate the vehicle 10. In contrast, in the above configuration, when the target rotational speed TRS is greater than the second rotational speed threshold RTh2 in the determination process, it is also determined that the driver intends to decelerate the vehicle 10 when the accelerator position change rate ACCPR is less than or equal to the second deceleration threshold DTh2. The second deceleration threshold DTh2 allows the intention of the driver to decelerate the vehicle to be recognized even if such intention cannot be recognized with the first deceleration threshold DTh1. If the above configuration is adopted, fuel efficiency can be improved for a predetermined period when the vehicle is moderately decelerated such that the engine rotational speed NE decreases from a rotational engine speed range in which the engine rotational speed NE is greater than or equal to the second rotational speed threshold RTh2 and becomes less than the second rotational speed threshold RTh2.

### Modified Examples

The present embodiment can be implemented with the following modifications. The present embodiment and the following modified examples can be implemented in combination with each other within a technically consistent range.

In the above embodiment, the controller for the internal combustion engine according to one embodiment is applied to the hybrid electric vehicle 10 including the engine 11, the first motor generator 12, and the second motor generator 13. However, this is merely an example. The controller for the internal combustion engine may be applied to a vehicle including only the engine 11.

In the above embodiment, step S300, step S304, and step S306 are executed. The process of determining whether the accelerator position change rate ACCPR is greater than or equal to the first acceleration threshold ATh1 in step S300 may be omitted. Alternatively, the process of determining whether the accelerator position change rate ACCPR is less than or equal to the first deceleration threshold DTh1 may be omitted. Step S304 may be omitted. Step S306 may be omitted.

In the above embodiment, when the target rotational speed TRS is greater than or equal to the second rotational speed threshold RTh2, the target output torque TOT of the fuel efficiency operation line FELn matches the target output torque TOT of the booming noise avoidance operation line NVLn. However, this is merely an example. The target output torque TOT of the fuel efficiency operation line FELn may be greater than the target output torque TOT of the booming noise avoidance operation line NVLn.

In the above embodiment, when the target rotational speed TRS is less than or equal to the first rotational speed threshold RTh1, the target output torque TOT of the fuel efficiency operation line FELn matches the target output torque TOT of the booming noise avoidance operation line NVLn. However, this is merely an example. The target output torque TOT of the fuel efficiency operation line FELn may be greater than the target output torque TOT of the booming noise avoidance operation line NVLn.

In the embodiments described above, the vehicle controller 39, the engine controller 38, and the PCU 27 each include a CPU, ROM, and RAM and executes software processing. However, this is only an example. For example, the vehicle controller 39 may include a dedicated hardware circuit (e.g., ASIC, etc.) that performs at least part of the software processing executed in the above embodiment. That is, the vehicle controller 39 may have any of the following configurations (a) to (c). (a) The vehicle controller 39 includes a processing device that executes all processes according to a program, and a program storage device such as a ROM that stores the program. That is, the vehicle controller 39 includes a software execution device. (b) The vehicle controller 39 includes a processing device that executes a part of a process according to a program and a program storage device. In addition, the vehicle controller 39 has a dedicated hardware circuit to execute the rest of the process. (c) The vehicle controller 39 is equipped with a dedicated hardware circuit that executes all of the processes. Here, there may be a plurality of software execution devices and/or dedicated hardware circuits. The same applies to the engine controller 38 and the PCU 27. That is, the processing may be executed by processing circuitry including at least one of the software execution devices or the dedicated hardware circuits. There may be a plurality of software execution devices and dedicated hardware circuits included in the processing circuitry. A program storage device or computer-readable medium includes any available medium accessible by a general purpose or dedicated computer.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A controller for an internal combustion engine, the controller comprising:
processing circuitry; and
storage, wherein
(i) the storage stores information of a plurality of operation lines,
(ii) each of the operation lines is data including a plurality of target operation points for the internal combustion engine,
(iii) each of the target operation points is a set of a target rotational speed and a target output torque for the internal combustion engine,
(iv) the operation lines include a fuel efficiency operation line for optimizing fuel consumption of the internal combustion engine and a booming noise avoidance operation line for keeping a booming noise below a certain limit in the internal combustion engine,
(v) an operation point region in which the booming noise exceeding the certain limit is generated is a booming noise region,
(vi) the booming noise region is a region in which a rotational speed of the internal combustion engine is within a predetermined range and an output torque of the internal combustion engine is greater than or equal to an output torque threshold determined in accordance with the rotational speed of the internal combustion engine,
(vii) the fuel efficiency operation line passes through the booming noise region, whereas the booming noise avoidance operation line sets the target output torque to be lower than that of the fuel efficiency operation line so as not to pass through the booming noise region,
the processing circuitry is configured to execute:
a first process that controls the internal combustion engine according to the booming noise avoidance operation line,
a determination process that determines whether a driver intends to change a speed of a vehicle based on an accelerator position change rate that is a change amount of an accelerator position per unit time, and
a second process that controls the internal combustion engine according to the fuel efficiency operation line for a predetermined period after determination that the driver intends to change the speed of the vehicle.

2. The controller according to claim 1, wherein the processing circuitry is configured to execute:
the determination process that determines that the driver intends to accelerate the vehicle when the accelerator position change rate is greater than or equal to an acceleration threshold; and
the second process that controls the internal combustion engine according to the fuel efficiency operation line for the predetermined period from when determined in the determination process that the driver intends to accelerate the vehicle.

3. The controller according to claim 1, wherein the processing circuitry is configured to execute:
the determination process that determines that the driver intends to decelerate the vehicle when the accelerator position change rate is less than or equal to a deceleration threshold; and
the second process that controls the internal combustion engine according to the fuel efficiency operation line for the predetermined period from when determined in the determination process that the driver intends to decelerate the vehicle.

4. The controller according to claim 1, wherein:
when the target rotational speed is less than or equal to a first rotational speed threshold, the target output torque of the fuel efficiency operation line matches the target output torque of the booming noise avoidance operation line;
the fuel efficiency operation line diverges from the booming noise avoidance operation line at the first rotational speed threshold such that the target output torque of the fuel efficiency operation line is greater than the target output torque of the booming noise avoidance operation line;
the processing circuitry is configured to determine that the driver intends to accelerate the vehicle when the accelerator position change rate is greater than or equal to a first acceleration threshold in the determination process;
the processing circuitry is configured to also determine that the driver intends to accelerate the vehicle when the target rotational speed is less than the first rotational speed threshold and the accelerator position change rate is greater than or equal to a second acceleration threshold in the determination process; and
the second acceleration threshold is less than the first acceleration threshold.

5. The controller according to claim 1, wherein:
when the target rotational speed is greater than or equal to a second rotational speed threshold, the target output torque of the fuel efficiency operation line matches the target output torque of the booming noise avoidance operation line;
the fuel efficiency operation line diverges from the booming noise avoidance operation line at the second rotational speed threshold such that the target output torque of the fuel efficiency operation line is greater than the target output torque of the booming noise avoidance operation line;
the processing circuitry is configured to determine that the driver intends to decelerate the vehicle when the accelerator position change rate is less than or equal to a first deceleration threshold in the determination process;
the processing circuitry is configured to also determine that the driver intends to decelerate the vehicle when the target rotational speed is greater than the second rotational speed threshold and the accelerator position change rate is less than or equal to a second deceleration threshold in the determination process; and
the second deceleration threshold is greater than the first deceleration threshold.

6. The controller according to claim 4, wherein:
when the target rotational speed is greater than or equal to a second rotational speed threshold, the target output torque of the fuel efficiency operation line matches the target output torque of the booming noise avoidance operation line;
the fuel efficiency operation line diverges from the booming noise avoidance operation line at the second rotational speed threshold such that the target output torque of the fuel efficiency operation line is greater than the target output torque of the booming noise avoidance operation line;
the processing circuitry is configured to determine that the driver intends to decelerate the vehicle when the accelerator position change rate is less than or equal to a first deceleration threshold in the determination process;
the processing circuitry is configured to also determine that the driver intends to decelerate the vehicle when the target rotational speed is greater than the second rotational speed threshold and the accelerator position change rate is less than or equal to a second deceleration threshold in the determination process; and
the second deceleration threshold is greater than the first deceleration threshold.

7. A method for controlling an internal combustion engine, wherein
(i) storage stores information of a plurality of operation lines,
(ii) each of the operation lines is data including a plurality of target operation points for the internal combustion engine,
(iii) each of the target operation points is a set of a target rotational speed and a target output torque for the internal combustion engine,
(iv) the operation lines include a fuel efficiency operation line for optimizing fuel consumption of the internal combustion engine and a booming noise avoidance operation line for keeping a booming noise below a certain limit in the internal combustion engine,
(v) an operation point region in which the booming noise exceeding the certain limit is generated is a booming noise region,
(vi) the booming noise region is a region in which a rotational speed of the internal combustion engine is within a predetermined range and an output torque of the internal combustion engine is greater than or equal to an output torque threshold determined in accordance with the rotational speed of the internal combustion engine,
(vii) the fuel efficiency operation line passes through the booming noise region, whereas the booming noise avoidance operation line sets the target output torque to be lower than that of the fuel efficiency operation line so as not to pass through the booming noise region,
the method comprising:
executing a process that obtains the booming noise avoidance operation line and the fuel efficiency operation line from the storage;
executing a first process that controls the internal combustion engine according to the booming noise avoidance operation line;
executing a determination process that determines whether a driver intends to change a speed of a vehicle based on an accelerator position change rate that is a change amount of an accelerator position per unit time; and
executing a second process that controls the internal combustion engine according to the fuel efficiency operation line for a predetermined period after determination that the driver intends to change the speed of the vehicle.
